(19) United States
(12) Patent Application Publication
(10) Pub. No.: US 2011/0241561 A1
(43) Pub. Date: Oct. 6, 2011

(54) Method of Controlling an Electronic Dimming Ballast During Low Temperature Conditions

(75) Inventors: Venkatesh Chitta, Center Valley, PA (US); Mehmet Ozbek, Allentown, PA (US); Jonathan Robert Quayle, Bethlehem, PA (US); Mark S. Taipale, Harleysville, PA (US); Dragan Veskovic, Allentown, PA (US)

(73) Assignee: LUTRON ELECTRONICS CO., INC., Coopersburg, PA (US)

(21) Appl. No.: 12/955,988

(22) Filed: Nov. 30, 2010

Related U.S. Application Data
(60) Provisional application No. 61/321,316, filed on Apr. 6, 2010.
(60) Provisional application No. 61/374,884, filed on Aug. 18, 2010.

(51) Int. Cl. H05B 41/16

(52) U.S. Cl. 315/287

(57) ABSTRACT

An electronic ballast circuit for driving a gas discharge lamp is operable to control the lamp to avoid flicking and flashing of the intensity of the lamp during low temperature conditions. The ballast circuit includes an inverter circuit for receiving a DC bus voltage and for generating a high-frequency output voltage, a resonant tank circuit for receiving the high-frequency output voltage and generating a sinusoidal voltage for driving said lamp, and a control circuit operatively coupled to the inverter circuit for adjusting an intensity of the lamp between a minimum intensity and a maximum intensity. The control circuit receives a control signal representative of a lamp temperature of the lamp, and increases the minimum intensity of the lamp if the lamp temperature of the lamp drops below a cold temperature threshold. In addition, the ballast circuit may also include a temperature sensing circuit operable to generate the control signal representative of the lamp temperature of the lamp.

### CROSS-REFERENCE TO RELATED APPLICATIONS

This application is a non-provisional application of commonly-assigned U.S. Provisional Application No. 61/321,316, filed Apr. 6, 2010, and U.S. Provisional Application No. 61/374,884, filed Aug. 18, 2010, both entitled METHOD OF CONTROLLING AN ELECTRICAL DIMMING BALLAST DURING LOW TEMPERTATURE CONDITIONS, the entire disclosures of which are hereby incorporated by reference.

### BACKGROUND OF THE INVENTION

1. Field of the Invention

The present invention relates to electronic ballasts for controlling a gas discharge lamp, such as a fluorescent lamp, and more specifically, to a method of controlling the gas discharge lamp to avoid flickering and flashing of the lamp during low temperature conditions.

2. Description of the Related Art

In order to reduce energy consumption of artificial illumination sources, the use of high-efficiency light sources is increasing, while the use of low-efficiency light sources (i.e., incandescent lamps, halogen lamps, and other low-efficacy light sources) is decreasing. High-efficiency light sources may comprise, for example, gas discharge lamps (such as compact fluorescent lamps), phosphor-based lamps, high-intensity discharge (HID) lamps, light-emitting diode (LED) light sources, and other types of high-efficacy light sources. Lighting control devices, such as dimmer switches, allow for the control of the amount of power delivered from a power source to a lighting load, such that the intensity of the lighting load may be dimmed from a high-end (i.e., maximum intensity) to a low-end (i.e., minimum) intensity. Both high-efficiency and low-efficiency light sources can be dimmed, but the dimming characteristics of these two types of light sources typically differ.

Because of the increase in use of high-efficiency light sources, fluorescent lamps are often being installed in outdoor installations where the lamp may be subject to low operating temperatures. However, typical fluorescent lamps may not operate correctly and may flicker if the fluorescent lamps are dimmed in cold ambient temperatures. As the fluorescent lamp is dimmed towards the low-end intensity, the magnitude of a lamp voltage required to drive the fluorescent lamp increases. In addition, as the temperature of the lamp decreases, the magnitude of the lamp voltage required to drive the fluorescent lamp increases even further. These increases in the lamp voltage required to drive the fluorescent lamp can cause instability in the intensity of the fluorescent lamp, particularly near the low-end intensity of the lamp, which may thus produce visible flickering or flashing of the fluorescent lamp. Thus, there is a need for a load control device for high-efficiency light sources that is able to stably dim the light sources to low intensities without flicker in low temperature conditions.

### SUMMARY OF THE INVENTION

According to an embodiment of the present invention, an electronic ballast circuit for driving a gas discharge lamp is operable to control the lamp to avoid flicking and flashing of the intensity of the lamp during low temperature conditions. The ballast circuit comprises an inverter circuit for receiving a DC bus voltage and for generating a high-frequency inverter output voltage, a resonant tank circuit for receiving the inverter output voltage and generating a sinusoidal voltage for driving said lamp, and a control circuit operatively coupled to the inverter circuit for adjusting an intensity of the lamp between a minimum intensity and a maximum intensity. The control circuit receives a control signal representative of a lamp temperature of the lamp, and increases the minimum intensity of the lamp if the lamp temperature of the lamp drops below a cold temperature threshold. In addition, the ballast circuit may further comprise a temperature sensing circuit operable to generate the control signal representative of the lamp temperature of the lamp. The temperature sensing circuit may be operatively coupled to the control circuit, such that the control circuit is operable to increase the minimum intensity of the lamp if the lamp temperature of the lamp drops below the cold temperature threshold.

In addition, a method of driving a gas discharge lamp to avoid flicking and flashing of the lamp during low temperature conditions is also described herein. The method comprises the steps of: (1) generating a high-frequency output voltage having an operating frequency; (2) adjusting the operating frequency so as to control an intensity of the lamp between a minimum intensity and a maximum intensity; (3) generating a temperature control signal representative of a lamp temperature of the lamp; (4) determining if the lamp temperature of the lamp is below a cold temperature threshold; and (5) increasing the minimum intensity of the lamp if the lamp temperature of the lamp is below the cold temperature threshold.

Other features and advantages of the present invention will become apparent from the following description of the invention that refers to the accompanying drawings.

### BRIEF DESCRIPTION OF THE DRAWINGS

The invention will now be described in greater detail in the following detailed description with reference to the drawings in which:

FIG. 1 is a simplified block diagram of a lighting control system including a dimmer and a hybrid light source having both a fluorescent lamp and a halogen lamp according to a first embodiment of the present invention;

FIG. 2 is a simplified side view of the hybrid light source of FIG. 1;

FIG. 3 is a simplified top cross-sectional view of the hybrid light source of FIG. 2;

FIG. 4A is a simplified graph showing a total correlated color temperature of the hybrid light source of FIG. 2 plotted with respect to a desired total lighting intensity of the hybrid light source;

FIG. 4B is a simplified graph showing a target fluorescent lamp lighting intensity, a target halogen lamp lighting intensity, and a total lighting intensity of the hybrid light source of FIG. 2 plotted with respect to the desired total lighting intensity;

FIG. 5 is a simplified block diagram of the hybrid light source of FIG. 2 according to the first embodiment;

FIG. 6A is a graph showing an example of the relationship between a minimum fluorescent intensity of the fluorescent lamp and a measured temperature of the hybrid light source of FIG. 2 according to the first embodiment of the present invention;

FIG. 6B is a graph showing an example of the relationship between the minimum fluorescent intensity of the fluorescent lamp and the measured temperature of the hybrid light source of FIG. 2 according to an alternate embodiment of the present invention;

FIG. 7 is a simplified flowchart of a fluorescent lamp control procedure executed periodically by a control circuit of the hybrid light source of FIG. 2 according to the first embodiment of the present invention;

FIG. 8 is a simplified block diagram of an electronic dimming ballast according to a second embodiment of the present invention; and

FIG. 9 is a simplified diagram of a lamp voltage monitor procedure executed periodically by a control circuit of the ballast of FIG. 8.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

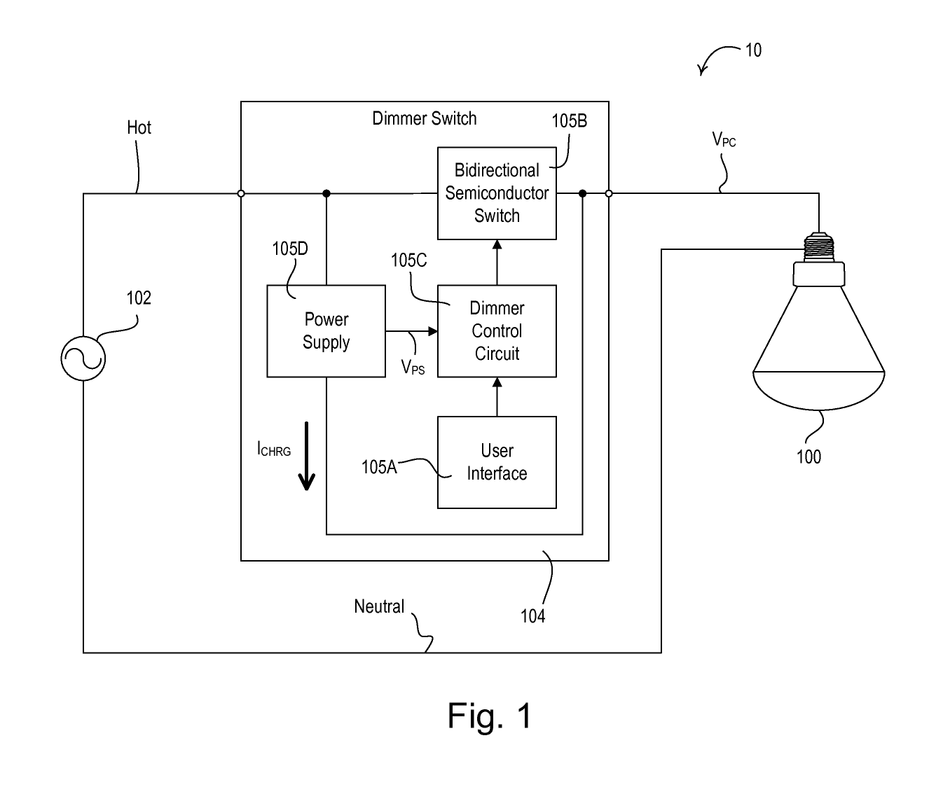

FIG. 1 is a simplified block diagram of a lighting control system 10 including a hybrid light source 100 according to a first embodiment of the present invention. The hybrid light source 100 is coupled to the hot side of an alternating-current (AC) power source 102 (e.g., 120 V_{AC}, 60 Hz) through a conventional two-wire dimmer switch 104 and is directly coupled to the neutral side of the AC power source. The dimmer switch 104 comprises a user interface 105A including an intensity adjustment actuator (not shown), such as a slider control or a rocker switch. The user interface 105A allows a user to adjust a desired total lighting intensity L_{DESIRED} of the hybrid light source 100 across a dimming range between a low-end lighting intensity L_{LE} (i.e., a minimum intensity, e.g., 0%) and a high-end lighting intensity L_{HE} (i.e., a maximum intensity, e.g., 100%).

The dimmer switch 104 typically includes a bidirectional semiconductor switch 105B, such as, for example, a thyristor (such as a triac) or two field-effect transistors (FETs) coupled in anti-series connection, for providing a phase-controlled voltage V_{PC} (i.e., a dimmed-hot voltage) to the hybrid light source 100. Using a standard forward phase-control dimming technique, a control circuit 105C renders the bidirectional semiconductor switch 105B conductive at a specific time each half-cycle of the AC power source, such that the bidirectional semiconductor switch remains conductive for a conduction period T_{CON} during each half-cycle. The dimmer switch 104 controls the amount of power delivered to the hybrid light source 100 by controlling the length of the conduction period T_{CON}. The dimmer switch 104 also often comprises a power supply 105D coupled across the bidirectional semiconductor switch 105B for powering the control circuit 105C. The power supply 105D generates a DC supply voltage V_{PS} by drawing a charging current I_{CHRG} from the AC power source 102 through the hybrid light source 100 when the bidirectional semiconductor switch 105B is non-conductive each half-cycle. An example of a dimmer switch having a power supply 105D is described in greater detail in U.S. Pat. No. 5,248,919, issued Sep. 29, 1993, entitled LIGHTING CONTROL DEVICE, the entire disclosure of which is hereby incorporated by reference.

Alternatively, the dimmer switch 104 could comprise a two-wire analog dimmer switch having a timing circuit (not shown) and a trigger circuit (not shown). The timing circuit conducts a timing current from the AC power source through the hybrid light source 100 when the bidirectional semiconductor switch 105B is non-conductive each half-cycle. The timing current is used to control when the bidirectional semiconductor switch 105B is rendered conductive each half-cycle.

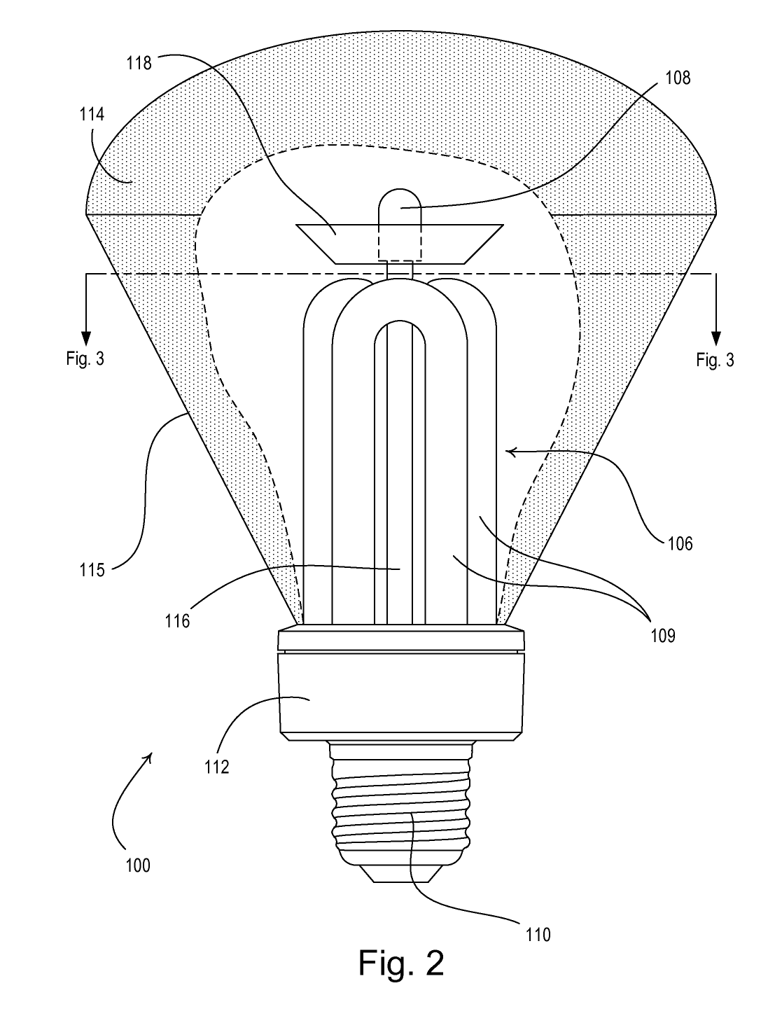

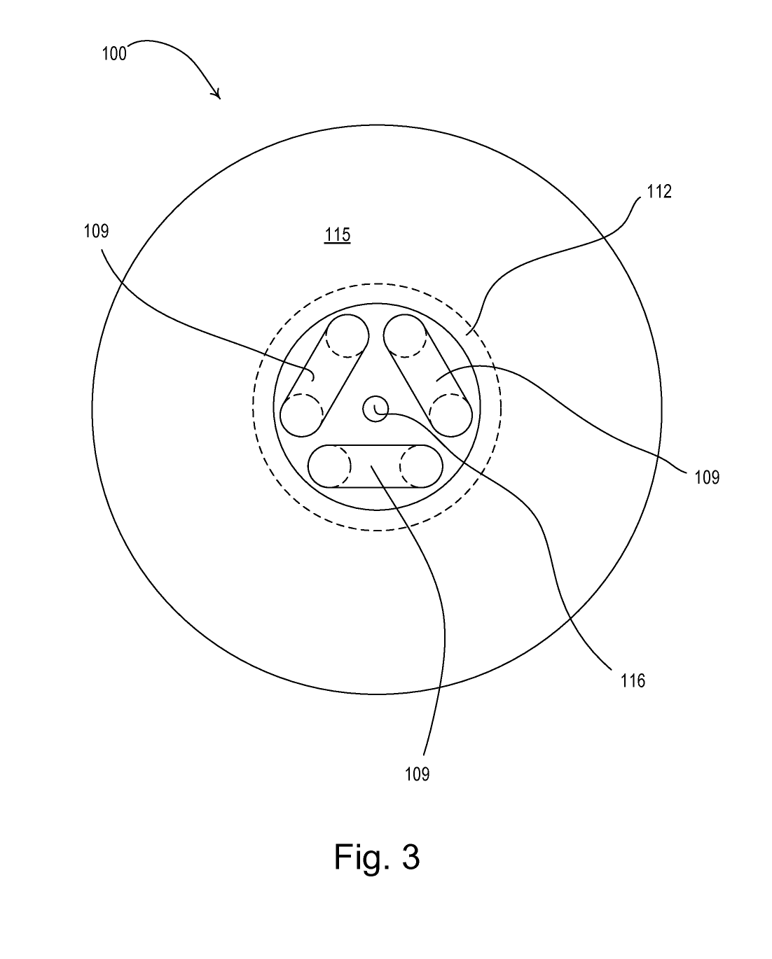

FIG. 2 is a simplified side view and FIG. 3 is a simplified top cross-sectional view of the hybrid light source 100. The hybrid light source 100 comprises both a discrete-spectrum lamp and a continuous-spectrum lamp. The discrete-spectrum lamp may comprise, for example, a gas discharge lamp (such as a compact fluorescent lamp 106), a phosphor-based lamp, a high-intensity discharge (HID) lamp, a light-emitting diode (LED) light source, or any suitable high-efficiency lamp having an at least partially-discrete spectrum. The compact fluorescent lamp 106 may comprise, for example, three curved gas-filled glass tubes 109 as shown in FIG. 2. The continuous-spectrum lamp may comprise, for example, an incandescent lamp (such as halogen lamp 108) or any suitable low-efficiency lamp having a continuous spectrum. For example, the halogen lamp 108 may comprise a low-voltage halogen lamp that may be energized by a voltage having a magnitude ranging from approximately 12 volts to 24 volts. Alternatively, the halogen lamp 108 may comprise a line-voltage halogen lamp (e.g., energized by an AC voltage having a magnitude of approximately 120 V_{AC}). The discrete-spectrum lamp (i.e., the fluorescent lamp 106) may have a greater efficacy than the continuous-spectrum lamp (i.e., the halogen lamp 108). For example, the fluorescent lamp 106 may be typically characterized by an efficacy greater than approximately 60 lm/W, while the halogen lamp 108 may be typically characterized by an efficacy less than approximately 30 lm/W.

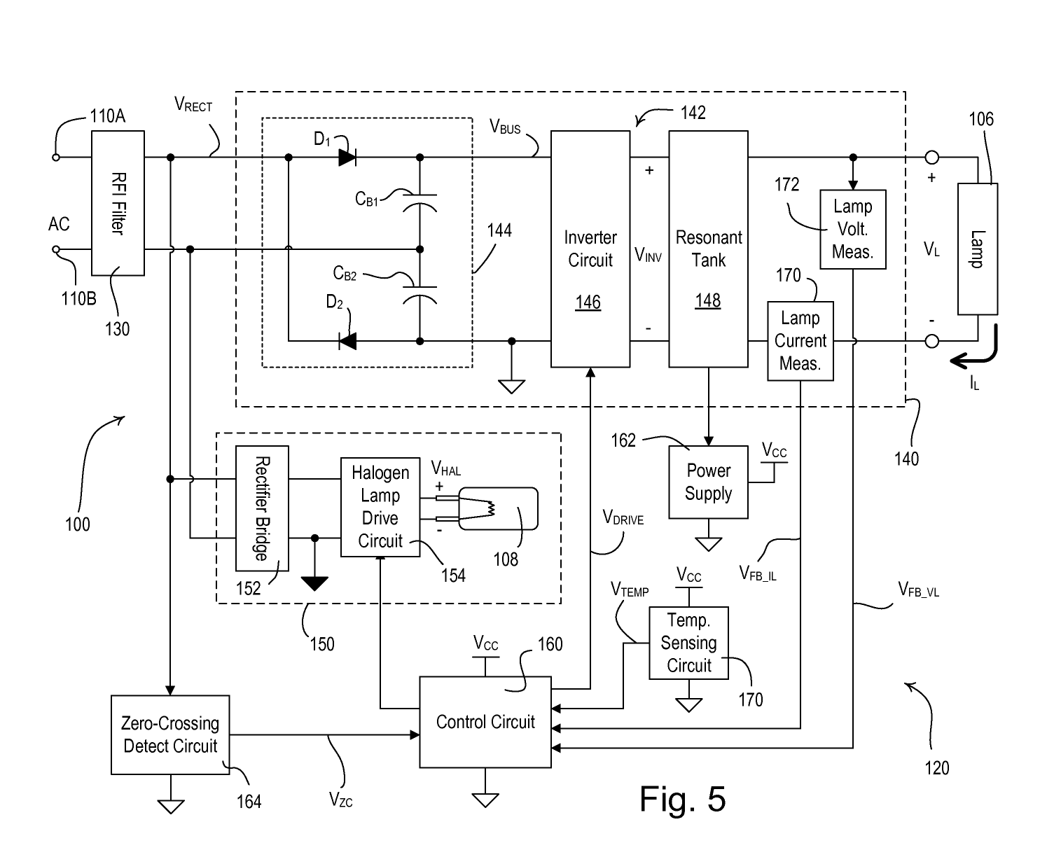

The hybrid light source 100 comprises, for example, a screw-in Edison base 110 for connection to a standard Edison socket, such that the hybrid light source may be coupled to the AC power source 102. The screw-in base 110 has two input terminals 110A, 110B (FIG. 5) for receipt of the phase-controlled voltage V_{PC} and for coupling to the neutral side of the AC power source 102. A hybrid light source electrical circuit 120 (FIG. 5) is housed in an enclosure 112 and controls the amount of power delivered from the AC power source to each of the fluorescent lamp 106 and the halogen lamp 108. Specifically, the electrical circuit 120 is operable to control the magnitude of a lamp current I_{L} conducted through the fluorescent lamp 106 (such that a lamp voltage V_{L} is generated across the lamp), and the magnitude of a halogen voltage V_{HAL} generated across the halogen lamp 108.

The fluorescent lamp 106 and halogen lamp 108 may be surrounded by a housing comprising a light diffuser 114 (e.g., a glass light diffuser) and a fluorescent lamp reflector 115. The fluorescent lamp reflector 115 directs the light emitted by the fluorescent lamp 106 away from the hybrid light source 100. The halogen lamp 108 is mounted to a post 116, such that the halogen lamp is situated beyond the terminal end of the fluorescent lamp 106. The post 116 allows the halogen lamp to be electrically connected to the hybrid light source electrical circuit 120. A halogen lamp reflector 118 surrounds the halogen lamp 108 and directs the light emitted by the halogen lamp in the same direction as the fluorescent lamp reflector 115 directs the light emitted by the fluorescent lamp 106.

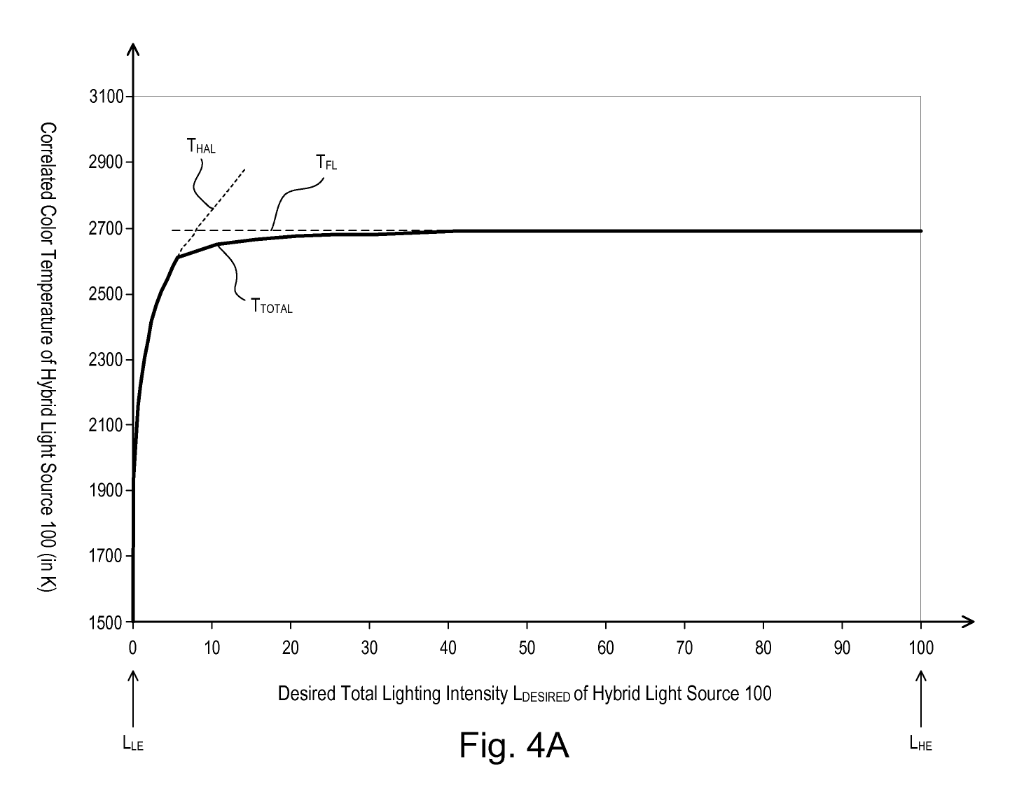

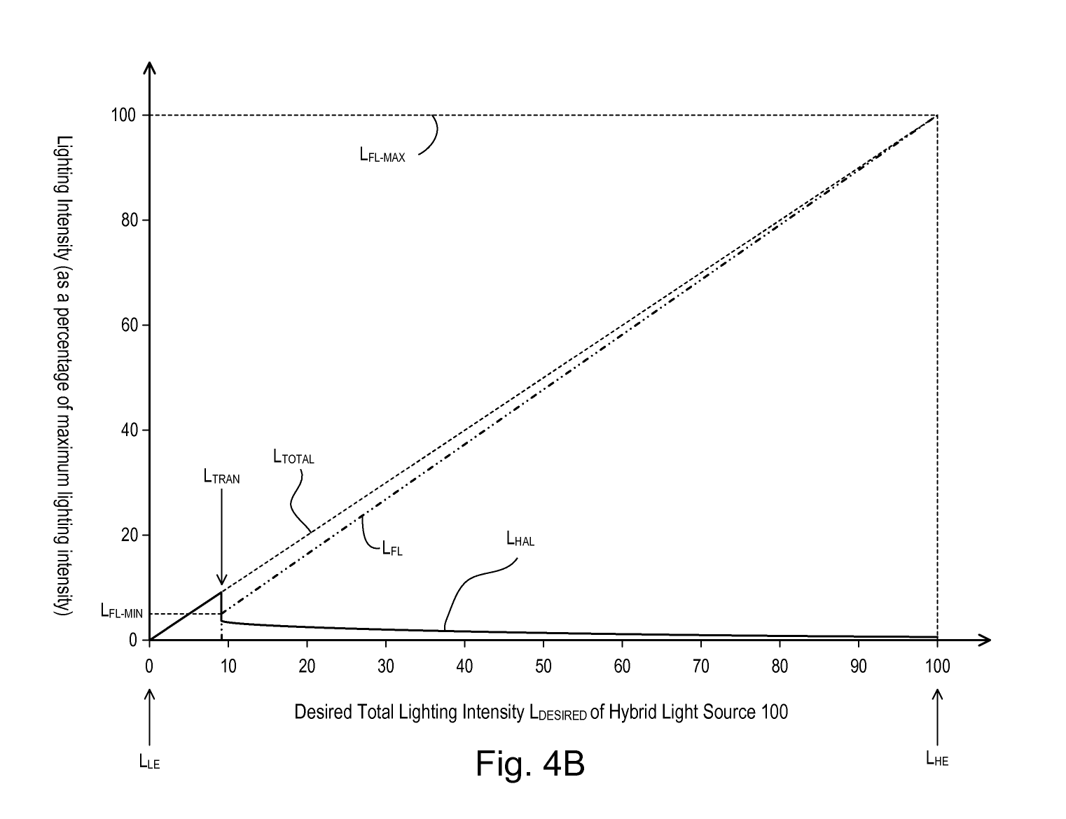

The hybrid light source 100 provides an improved color rendering index and correlated color temperature across the dimming range of the hybrid light source (particularly, near a low-end lighting intensity L_{LE}) as compared to a stand-alone compact fluorescent lamp. FIG. 4A is a simplified graph showing a total correlated color temperature T_{TOTAL} of the hybrid light source 100 plotted with respect to the desired total lighting intensity L_{DESIRED} of the hybrid light source 100 (as determined by the user actuating the intensity adjustment actuator of the user interface 105A of the dimmer switch 104). A correlated color temperature T_{FL} of a stand-alone compact fluorescent lamp remains constant at approximately 2700 Kelvin throughout most of the dimming range. A correlated color temperature T_{HAL} of a stand-alone halogen lamp decreases as the halogen lamp is dimmed to low intensities causing a desirable color shift towards the red portion of the color spectrum and creating a warmer effect on the human eye. The hybrid light source 100 is operable to individually control the intensities of the fluorescent lamp 106 and the halogen lamp 108, such that the total correlated color temperature T_{TOTAL} of the hybrid light source 100 more closely mimics the correlated color temperature of the halogen lamp at low light intensities, thus more closely meeting the expectations of a user accustomed to dimming low-efficiency lamps.

The hybrid light source 100 is further operable to control the fluorescent lamp 106 and the halogen lamp 108 to provide high-efficiency operation near the high-end intensity L_{HE}. FIG. 4B is a simplified graph showing a target fluorescent lighting intensity L_{FL}, a target halogen lighting intensity L_{HAL}, and a target total lighting intensity L_{TOTAL} plotted with respect to the desired total lighting intensity L_{DESIRED} of the hybrid light source 100 (as determined by the user actuating the intensity adjustment actuator of the dimmer switch 104). The intensity of the fluorescent lamp 106 is operable to be adjusted from a minimum fluorescent intensity L_{FL-MIN} to a maximum fluorescent intensity L_{FL-MAX}. The target fluorescent lighting intensity L_{FL} and the target halogen lighting intensity L_{HAL} (as shown in FIG. 4B) provide for a decrease in color temperature near the low-end intensity L_{LE} and high-efficiency operation near the high-end intensity L_{HE}. Near the high-end intensity L_{HE}, the fluorescent lamp 106 (i.e., the high-efficiency lamp) provides a greater percentage of the total light intensity L_{TOTAL} of the hybrid light source 100. As the total light intensity L_{TOTAL} of the hybrid light source 100 decreases, the halogen lamp 108 is controlled such that the halogen lamp begins to provide a greater percentage of the total light intensity.

Because the fluorescent lamp 106 cannot be dimmed to very low intensities without the use of more expensive and complex circuits, the fluorescent lamp 106 is controlled to be off at a transition intensity L_{TRAN}, e.g., approximately 8% (as shown in FIG. 4B) or up to approximately 30%. Below the transition intensity L_{TRAN}, the halogen lamp provides all of the total light intensity L_{TOTAL} of the hybrid light source 100, thus providing for a lower low-end intensity L_{LE} than can be provided by a stand-alone fluorescent lamp. Immediately below the transition intensity L_{TRAN}, the halogen lamp 108 is controlled to a maximum halogen intensity L_{HAL-MAX}, which is, for example, approximately 80% of the maximum rated intensity of the halogen lamp. When the desired total lighting intensity L_{DESIRED} of the hybrid light source 100 transitions above the transition intensity L_{TRAN}, the target halogen lighting intensity L_{HAL} is reduced below the maximum halogen intensity L_{HAL-MAX} and fluorescent lamp 106 is controlled to the minimum fluorescent intensity L_{FL-MIN}, such that the total light intensity L_{TOTAL} is approximately equal to the maximum halogen intensity L_{HAL-MAX}. Across the dimming range of the hybrid light source 100, the intensities of the fluorescent lamp 106 and the halogen lamp 108 are individually controlled such that the target total light intensity L_{TOTAL} of the hybrid light source 100 is substantially linear as shown in FIG. 4B.

The structure and operation of the hybrid light source 100 is described in greater detail in commonly-assigned, co-pending U.S. patent application Ser. No. 12/205,571, filed Sep. 8, 2008; U.S. patent application Ser. No. 12/553,612, filed Sep. 3, 2009; and U.S. patent application Ser. No. 12/704,781, filed Feb. 12, 2010; each entitled HYBRID LIGHT SOURCE. The entire disclosures of all three applications are hereby incorporated by reference.

Since the fluorescent lamp 106 is turned on at the transition intensity L_{TRAN} in the middle of the dimming range of the hybrid light source 100 as shown in FIG. 4B, it is desirable that visible flickering or flashing of the fluorescent lamp does not occur when the lamp transitions from off to on. As previously mentioned, the lamp voltage V_{L} required to drive the fluorescent lamp increases as the fluorescent lamp 106 is dimmed towards the minimum fluorescent intensity L_{FL-MIN} and also as a lamp temperature T_{L} of the fluorescent lamp decreases, which can cause instability and thus visible flickering or flashing of the fluorescent lamp. Accordingly, the hybrid light source 100 of the present invention is operable to increase the minimum fluorescent intensity L_{FL-MIN} of the fluorescent lamp 106 when the lamp temperature T_{L} of the lamp drops below a cold lamp temperature threshold T_{C} (e.g., approximately 40° C.) as will be described in greater detail below.

FIG. 5 is a simplified block diagram of the hybrid light source 100 showing the hybrid light source electrical circuit 120. The hybrid light source 100 comprises a radio-frequency interference (RFI) filter 130 coupled across the input terminals 110A, 110B for minimizing the noise provided to the AC power source 102. The hybrid light source 100 further comprises a high-efficiency light source circuit 140 (i.e., a discrete-spectrum light source circuit) for illuminating the fluorescent lamp 106 and a low-efficiency light source circuit 150 (i.e., a continuous-spectrum light source circuit) for illuminating the halogen lamp 108. A control circuit 160 simultaneously controls the operation of the high-efficiency light source circuit 140 and the low-efficiency light source circuit 150 to thus control the amount of power delivered to each of the fluorescent lamp 106 and the halogen lamp 108. The control circuit 160 may comprise, for example, a microprocessor, or alternatively, a programmable logic device (PLD), a microcontroller, an application specific integrated circuit (ASIC), or any other suitable processing device or control circuit. A power supply 162 generates a direct-current (DC) supply voltage V_{CC} (e.g., 5 V_{DC}) for powering the control circuit 160.

The control circuit 160 is operable to determine the desired total lighting intensity L_{DESIRED} of the hybrid light source 100 in response to a zero-crossing detect circuit 164 (i.e., as determined by the user actuating the intensity adjustment actuator of the dimmer switch 104). The zero-crossing detect circuit 164 provides a zero-crossing control signal V_{ZC}, representative of the zero-crossings of the phase-controlled voltage V_{PC}, to the control circuit 160. A zero-crossing is defined as the time at which the phase-controlled voltage V_{PC} changes from having a magnitude of substantially zero volts to having a magnitude greater than a predetermined zero-crossing threshold V_{TH-ZC} (and vice versa) each half-cycle. Specifically, the zero-crossing detect circuit 164 compares the magnitude of the rectified voltage to the predetermined zero-crossing threshold V_{TH-ZC} (e.g., approximately 20 V), and drives the zero-crossing control signal V_{ZC} high (i.e., to a logic high level, such as, approximately the DC supply voltage V_{CC1}) when the magnitude of the rectified voltage V_{RECT} is greater than the predetermined zero-crossing threshold V_{TH-ZC}. Further, the zero-crossing detect circuit 164 drives the zero-crossing control signal V_{ZC} low (i.e., to a logic low level, such as, approximately circuit common) when the magnitude of the rectified voltage V_{RECT} is less than the predetermined zero-crossing threshold V_{TH-ZC}. The control circuit 160 determines the length of the conduction period T_{CON} of the phase-controlled voltage V_{PC} in response to the zero-crossing control signal V_{ZC}, and then determines the target lighting intensities for both the fluorescent lamp 106 and the halogen lamp 108 to produce the target total lighting intensity L_{TOTAL} of the hybrid light source 100 in response to the conduction period T_{CON} of the phase-controlled voltage V_{PC}. Alternatively, the zero-crossing detect circuit 164 may provide some hysteresis in the level of the zero-crossing threshold V_{TH-ZC}.

The low-efficiency light source circuit 150 comprises a full-wave rectifier 152 for generating a rectified voltage V_{RECT} (from the phase-controlled voltage V_{PC}) and a halogen lamp drive circuit 154, which receives the rectified voltage V_{RECT} and controls the amount of power delivered to the halogen lamp 108. The low-efficiency light source circuit 150 is coupled between the rectified voltage V_{RECT} and the rectifier common connection (i.e., across the output of the front end circuit 130). The control circuit 160 is operable to control the magnitude of the halogen voltage V_{HAL} to thus control the intensity of the halogen lamp 108 to the target halogen lighting intensity corresponding to the present value of the desired total lighting intensity L_{DESIRED} of the hybrid light source 100, e.g., to the target halogen lighting intensity as shown in FIG. 4B. Since the halogen lamp 108 is a low-voltage halogen lamp, the halogen drive circuit 154 comprises a low-voltage transformer (not shown) coupled between the rectifier 152 and the halogen lamp.

The high-efficiency light source circuit 140 comprises a fluorescent drive circuit (e.g., a dimmable electronic ballast circuit 142) for receiving the phase-controlled voltage V_{PC} (via the RFI filter 130) and for driving the fluorescent lamp 106. Specifically, the phase-controlled voltage V_{PC} is coupled to a voltage doubler circuit 144, which generates a bus voltage V_{BUS} across two series connected bus capacitors C_{B1}, C_{B2}. The first bus capacitor C_{B1} is operable to charge through a diode D₁ during the positive half-cycles, while the second bus capacitor C_{B2} is operable to charge through a diode D₂ during the negative half-cycles. The ballast circuit 142 includes an inverter circuit 146 for converting the DC bus voltage V_{BUS} to a high-frequency inverter output voltage V_{INV} (e.g., a square-wave voltage). The inverter output voltage V_{INV} is characterized by an operating frequency f_{OP} (and an operating period T_{OP}=1/f_{OP}). The ballast circuit 142 further comprises an output circuit, e.g., a resonant tank circuit 148, for filtering the inverter output voltage V_{INV} to produce a substantially sinusoidal high-frequency AC voltage V_{SIN}, which is coupled to the electrodes of the fluorescent lamp 106. The high-efficiency lamp source circuit 140 further comprises a lamp current measurement circuit 170 (which provides a lamp current feedback signal V_{FB}_{_{—}}_{IL} representative of a magnitude of the lamp current I_{L} to the control circuit 160) and a lamp voltage measurement circuit 172 (which provides a lamp voltage feedback signal V_{FB}_{_{—}}_{VL} representative of a magnitude of the lamp voltage V_{L} to the control circuit).

The control circuit 160 is operable to control the inverter circuit 146 of the ballast circuit 140 to control the intensity of the fluorescent lamp 106 to the target fluorescent lighting intensity L_{FL} corresponding to the present value of the desired total lighting intensity L_{DESIRED} of the hybrid light source 100, e.g., to the target fluorescent lighting intensity L_{FL} as shown in FIG. 4B. The control circuit 160 determines a target lamp current I_{TARGET} for the fluorescent lamp 106 that corresponds to the target fluorescent lighting intensity L_{FL} in response to the zero-crossing control signal V_{ZC} from the zero-crossing detect circuit 164. The control circuit 160 then controls the operation of the inverter circuit 146 in response to the lamp voltage feedback signal V_{FB}_{_{—}}_{VL} and the lamp current feedback signal V_{FB}_{_{—}}_{IL} in order to control the lamp current I_{L} towards the target lamp current I_{TARGET}.

The hybrid light source electrical circuit 120 further comprises a temperature sensing circuit 180 that is coupled to the control circuit 160. The temperature sensing circuit 180 generates a measured temperature control signal V_{TEMP} that is representative of a measured temperature T_{M} measured by the temperature sensing circuit. Since the hybrid light source electrical circuit 120 is housed in the enclosure 112 in close vicinity to the fluorescent lamp 106, the measured temperature T_{M} measured by the temperature sensing circuit 180 is representative of the lamp temperature T_{L} of the fluorescent lamp 106. For example, the temperature sensing circuit 180 may be located close to the connection points between the dimmable electronic ballast circuit 142 and the fluorescent lamp 106. The temperature sensing circuit 180 may comprise for example a negative-temperature-coefficient (NTC) thermistor (not shown) coupled in series with a resistor (not shown), where the supply voltage V_{CC} is coupled across the series combination of the NTC thermistor and the resistor. The impedance of the NTC thermistor changes as a function of the measured temperature T_{M}, such that the measured temperature control signal V_{TEMP} may be generated at the junction of the NTC thermistor and the resistor. Alternatively, the temperature sensing circuit 180 could comprises a temperature sensor integrated circuit (not shown).

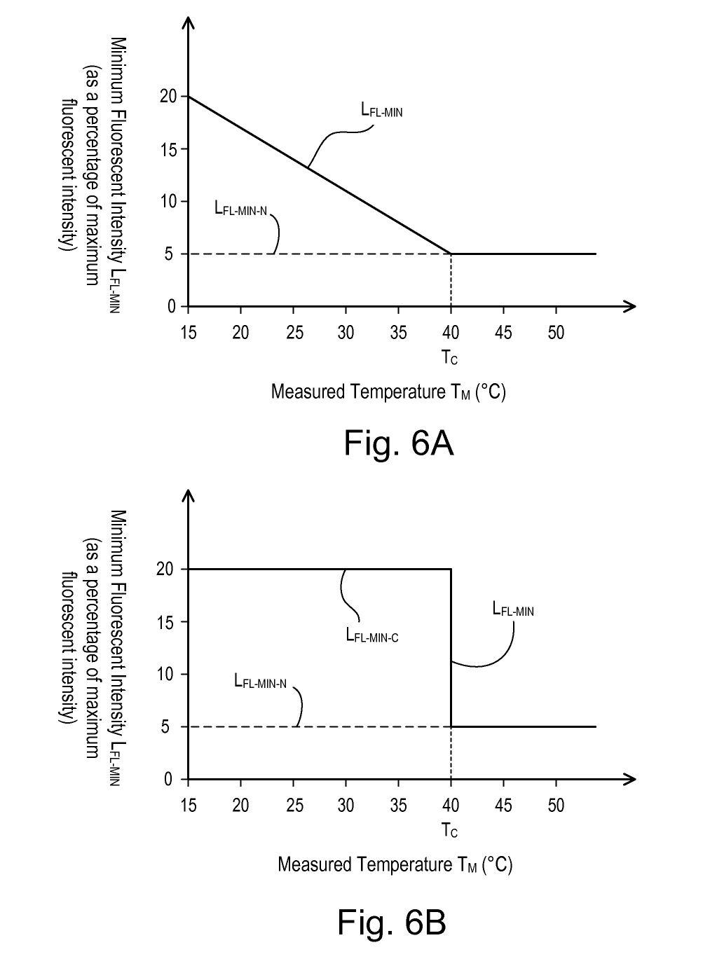

The control circuit 160 is operable to adjust the minimum fluorescent intensity L_{FL-MIN} of the fluorescent lamp 106 in response to the measured temperature control signal V_{TEMP} (i.e., the measured temperature T_{M} measured by the temperature sensing circuit 180). FIG. 6A is a graph showing an example of the relationship between the minimum fluorescent intensity L_{FL-MIN} of the fluorescent lamp 106 and the measured temperature T_{M} of the temperature sensing circuit 180. When the measured temperature T_{M} is greater than or equal to the cold lamp temperature threshold T_{C}, the minimum fluorescent intensity L_{FL-MIN} is maintained constant at a normal minimum fluorescent intensity L_{FL-MIN-N} (e.g., approximately 5% of the maximum possible intensity of the fluorescent lamp 106). When the measured temperature T_{M} drops below the cold lamp temperature threshold T_{C}, the minimum fluorescent intensity L_{FL-MIN} is increased continuously, for example, linearly as the measured temperature T_{M} decreases as shown in FIG. 6A. For example, the minimum fluorescent intensity L_{FL-MIN} may be increased at a rate of approximately 0.6% per 1° C. change in the measured temperature T_{M}, such that the minimum fluorescent intensity L_{FL-MIN} is approximately 20% when the measured temperature T_{M} is approximately 15° C. Alternatively, the minimum fluorescent intensity L_{FL-MIN} could be controlled according to a step function as shown in FIG. 6B, such that the minimum fluorescent intensity L_{FL-MIN} is simply increased to a cold minimum fluorescent intensity L_{FL-MIN-C} (e.g., approximately 20%) when the measured temperature T_{M} drops below the cold lamp temperature threshold T_{C}.

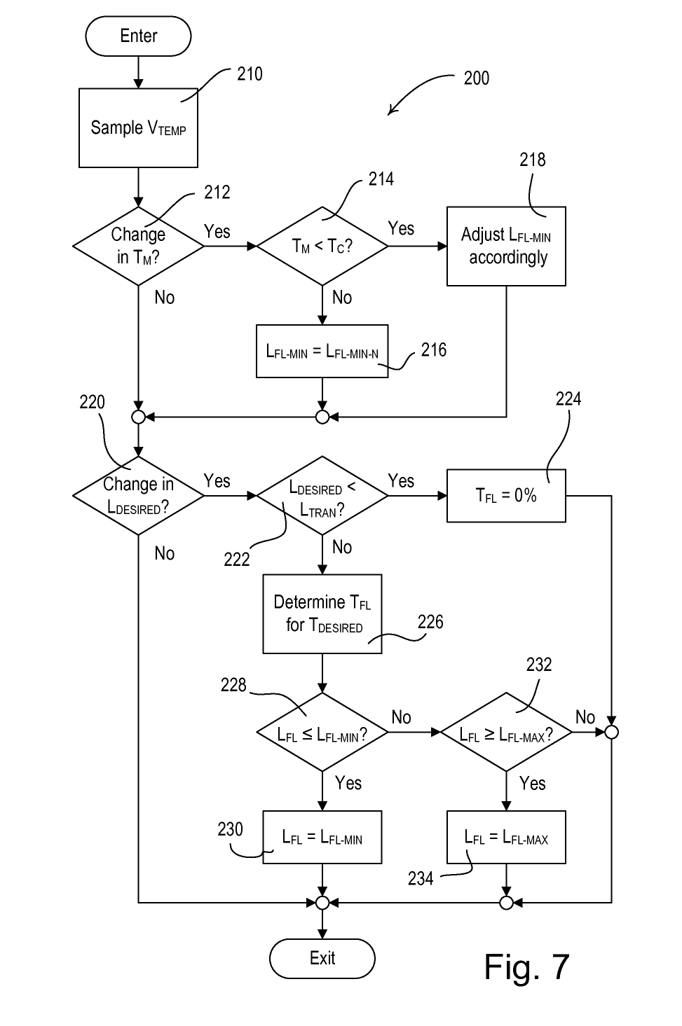

FIG. 7 is a simplified flowchart of a fluorescent lamp control procedure 200 executed periodically (e.g., every 100 μsec) by the control circuit 160 (i.e., the microprocessor) of the hybrid light source 100 according to the embodiment of the present invention. The control circuit 160 first samples the temperature control signal V_{TEMP} of the temperature sensing circuit 180 at step 210. If there is presently a change in the measured temperature T_{M} at step 212, the control circuit 160 determines if the measured temperature T_{M} is below the cold temperature threshold T_{C} at step 214. If the measured temperature T_{M} is greater than or equal to the cold temperature threshold T_{C} at step 214, the control circuit 160 sets the minimum fluorescent intensity L_{FL-MIN} equal to the normal minimum fluorescent intensity L_{FL-MIN-N} (i.e., approximately 5%) at step 216. If the measured temperature T_{M} is less than the cold temperature threshold T_{C} at step 214, the control circuit 160 adjusts the minimum fluorescent intensity L_{FL-MIN} appropriately at step 218. For example, the control circuit 160 may increase the minimum fluorescent intensity L_{FL-MIN} linearly as the measured temperature T_{M} decreases as shown in FIG. 6A, or according to a step function as shown in FIG. 6B.

If there is presently a change in the desired total lighting intensity L_{DESIRED} of the hybrid light source 100 at step 220 (i.e., as determined from the zero-crossing control signal V_{ZC} of the zero-crossing detect circuit 164), the control circuit 160 determines if the new desired total lighting intensity L_{DESIRED} is less than the transition intensity L_{TRAN} at step 222. If so, the control circuit 160 sets the target fluorescent lighting intensity L_{FL} equal to 0% at step 224 (i.e., the fluorescent lamp 106 is off), and the fluorescent lamp control procedure 200 exits. If the desired total lighting intensity L_{DESIRED} is greater than or equal to the transition intensity L_{TRAN} at step 222, the control circuit 160 determines the target fluorescent lighting intensity L_{FL} as a function of the desired total lighting intensity L_{DESIRED} (e.g., according to the graph shown in FIG. 4B). If the target fluorescent lighting intensity L_{FL} (determined at step 226) is less than or equal to the minimum fluorescent intensity L_{FL-MIN} at step 228, the control circuit 160 sets the target fluorescent lighting intensity L_{FL} equal to the minimum fluorescent intensity L_{FL-MIN} at step 230, before the fluorescent lamp control procedure 200 exits. If the target fluorescent lighting intensity L_{FL} is greater than the minimum fluorescent intensity L_{FL-MIN} at step 228, and is greater than or equal to the maximum fluorescent intensity L_{FL-MAX} at step 232, the control circuit 160 sets the target fluorescent lighting intensity L_{FL} equal to the maximum fluorescent intensity L_{FL-MAX} at step 234, before the fluorescent lamp control procedure 200 exits.

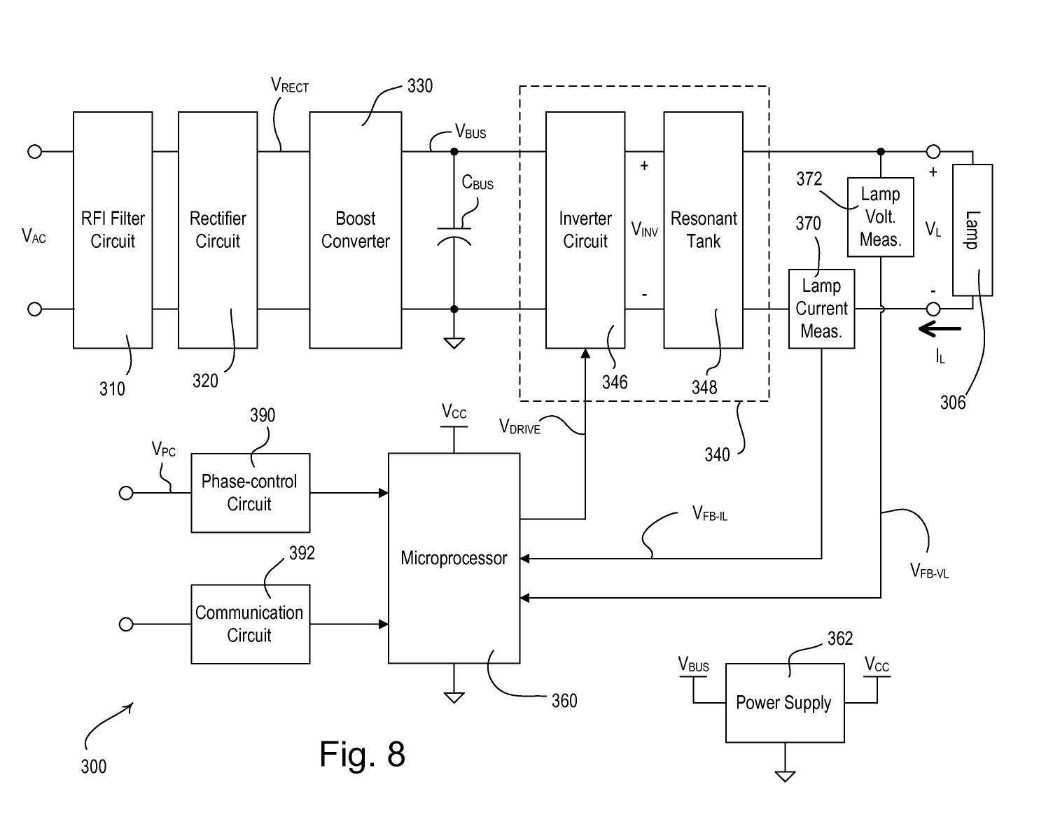

FIG. 8 is a simplified block diagram of an electronic dimming ballast 300 according to a second embodiment of the present invention. The ballast 300 comprises a hot terminal H and a neutral terminal N that are adapted to be coupled to an alternating-current (AC) power source (not shown) for receiving an AC mains line voltage V_{AC}. The ballast 300 is adapted to be coupled between the AC power source and a gas discharge lamp (e.g., a fluorescent lamp 306), such that the ballast is operable to control of the amount of power delivered to the lamp and thus the intensity of the lamp. The ballast 300 comprises an RFI (radio frequency interference) filter circuit 310 for minimizing the noise provided on the AC mains, and a rectifier circuit 320 for generating a rectified voltage V_{RECT} from the AC mains line voltage V_{AC}. The ballast 300 further comprises a boost converter 330 for generating a direct-current (DC) bus voltage V_{BUS} across a bus capacitor C_{BUS}. The DC bus voltage V_{BUS} typically has a magnitude (e.g., 465 V) that is greater than the peak magnitude V_{PK} of the AC mains line voltage V_{AC} (e.g., 170 V). The boost converter 330 also operates as a power-factor correction (PFC) circuit for improving the power factor of the ballast 300. The ballast 300 also includes a load control circuit 340 comprising an inverter circuit 346 and a resonant tank circuit 348. The inverter circuit 346 converts the DC bus voltage V_{BUS} to a high-frequency AC voltage, while the resonant tank circuit 348 couples the high-frequency AC voltage generated by the inverter circuit to filaments of the lamp 306.

The ballast 300 further comprises a control circuit 360 for controlling the intensity of the lamp 306 to a target intensity L_{TARGET} between a low-end (i.e., minimum) intensity L_{LE} (e.g., 1%) and a high-end (i.e., maximum) intensity L_{HE} (e.g., 100%). The control circuit 360 may comprise, a microprocessor, a microcontroller, a programmable logic device (PLD), an application specific integrated circuit (ASIC), or any suitable type of controller or control circuit. The control circuit 360 is coupled to the inverter circuit 346 and provides a drive control signal V_{DRIVE} to the inverter circuit for controlling the magnitude of a lamp voltage V_{L} generated across the lamp 306 and a lamp current I_{L} conducted through the lamp. Accordingly, the control circuit 360 is operable to turn the lamp 306 on and off and adjust (i.e., dim) the intensity of the lamp. The control circuit 360 receives a lamp current feedback signal V_{FB-IL}, which is generated by a lamp current measurement circuit 370 and is representative of the magnitude of the lamp current I_{L}. The control circuit 360 also receives a lamp voltage feedback signal V_{FB-VL}, which is generated by a lamp voltage measurement circuit 372 and is representative of the magnitude of the lamp voltage V_{L}. The ballast 300 also comprises a power supply 362, which receives the bus voltage V_{BUS} and generates a DC supply voltage V_{CC} (e.g., approximately five volts) for powering the control circuit 360 and other low-voltage circuitry of the ballast.

The ballast 300 may comprise a phase-control circuit 390 for receiving a phase-control voltage V_{PC} (e.g., a forward or reverse phase-control signal) from a standard phase-control dimmer (not shown). The control circuit 360 is coupled to the phase-control circuit 390, such that the microprocessor is operable to determine the target intensity L_{TARGET} for the lamp 306 from the phase-control voltage V_{PC}. The ballast 300 may also comprise a communication circuit 392, which is coupled to the control circuit 360 and allows the ballast to communicate (i.e., transmit and receive digital messages) with the other control devices on a communication link (not shown), e.g., a wired communication link or a wireless communication link, such as a radio-frequency (RF) or an infrared (IR) communication link. Examples of ballasts having communication circuits are described in greater detail in commonly-assigned U.S. Pat. No. 7,489,090, issued Feb. 10, 2009, entitled ELECTRONIC BALLAST HAVING ADAPTIVE FREQUENCY SHIFTING; U.S. Pat. No. 7,528,554, issued May 5, 2009, entitled ELECTRONIC BALLAST HAVING A BOOST CONVERTER WITH AN IMPROVED RANGE OF OUTPUT POWER; and U.S. Pat. No. 7,764,479, issued Jul. 27, 2010, entitled COMMUNICATION CIRCUIT FOR A DIGITAL ELECTRONIC DIMMING BALLAST, the entire disclosures of which are hereby incorporated by reference.

According to the second embodiment of the present invention, the control circuit 360 infers the lamp temperature T_{L} of the fluorescent lamp 306 from the magnitude of the lamp voltage V_{L}. Since the lamp voltage V_{L} is dependent upon the lamp temperature T_{L} of the fluorescent lamp 306, the lamp voltage feedback signal V_{FB-VL} generated by the lamp voltage measurement circuit 372 is representative of the lamp temperature T_{L} of the fluorescent lamp 306. Accordingly, the control circuit 360 is operable to increase the low-end intensity L_{LE} if the magnitude of the lamp voltage V_{L} exceeds a maximum lamp voltage limit V_{L-LIMIT} (e.g., approximately 270 V_{RMS}). For example, the control circuit 360 may increase the low-end intensity L_{LE} so as to limit the magnitude of the lamp voltage V_{L} to the maximum lamp voltage limit V_{L-LIMIT}.

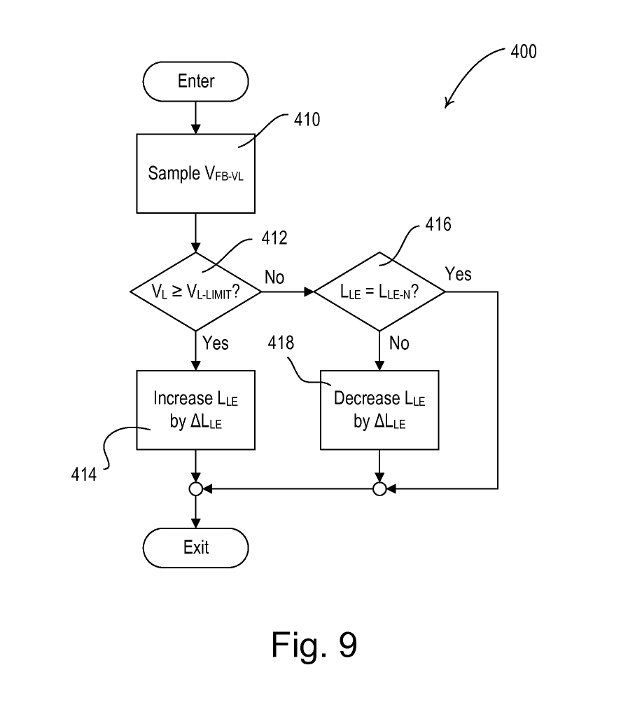

FIG. 9 is a simplified diagram of a lamp voltage monitor procedure 400 executed periodically (e.g., every 100 msec) by the control circuit 360 of the ballast 300. The control circuit 360 first samples the lamp voltage feedback signal V_{FB-VL} at step 410. If the sampled value of the lamp voltage feedback signal V_{FB-VL} is greater than or equal to the maximum lamp voltage limit V_{L-LIMIT} at step 412, the control circuit 360 increases the low-end intensity L_{LE} by a predetermined value ΔL_{LE} (e.g., approximately 1%) at step 414, and the lamp voltage monitor procedure 400 exits. The control circuit 360 will continue to increase the low-end intensity L_{LE} by the predetermined value ΔL_{LE} at step 414 each time that the lamp voltage monitor procedure 400 is executed until the lamp voltage feedback signal V_{FB-VL} is less than the maximum lamp voltage limit V_{L-LIMIT} at step 412.

If the lamp voltage feedback signal V_{FB-VL} is less than the maximum lamp voltage limit V_{L-LIMIT} at step 412, and the low-end intensity L_{LE} is not equal to a normal low-end intensity L_{LE-N} (e.g., approximately 1%) at step 416, the control circuit 360 decreases the low-end intensity L_{LE} by the predetermined value ΔL_{LE} at step 418, and the lamp voltage monitor procedure 400 exits. The control circuit 360 will continue to decrease the low-end intensity L_{LE} by the predetermined value ΔL_{LE} at step 418 each time that the lamp voltage monitor procedure 400 is executed. When the low-end intensity L_{LE} is equal to the normal low-end intensity L_{LE-N} at step 416, the lamp voltage monitor procedure 400 simply exits.

The method of the present invention for controlling a fluorescent lamp during low temperature conditions could be used in any dimmable electrical ballast to minimize flickering and flashing of the lamp during low temperature conditions. Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method of driving a gas discharge lamp comprising the steps of:
generating a high-frequency output voltage having an operating frequency;
adjusting the operating frequency so as to control an intensity of the lamp between a minimum intensity and a maximum intensity;
generating a temperature control signal representative of a lamp temperature of the lamp;
determining if the lamp temperature of the lamp is below a cold temperature threshold; and
increasing the minimum intensity of the lamp if the lamp temperature of the lamp is below the cold temperature threshold.

2. The method of claim 1, wherein generating a temperature control signal comprises generating a lamp voltage control signal representative of the magnitude of a lamp voltage across the lamp, the magnitude of the lamp voltage being dependent upon the lamp temperature of the lamp.

3. The method of claim 2, wherein increasing the minimum intensity of the lamp if the lamp temperature of the lamp is below the cold temperature threshold further comprises increasing the minimum intensity of the lamp if the magnitude of the lamp voltage exceeds a maximum lamp voltage limit.

4. The method of claim 3, wherein increasing the minimum intensity of the lamp if the lamp temperature of the lamp is below the cold temperature threshold further comprises increasing the minimum intensity of the lamp such that the magnitude of the lamp voltage across the lamp is limited to the maximum lamp voltage limit.

5. The method of claim 1, wherein increasing the minimum intensity of the lamp further comprises increasing the minimum intensity of the lamp continuously as the lamp temperature decreases below the cold temperature threshold.

6. The method of claim 5, wherein increasing the minimum intensity of the lamp further comprises increasing the minimum intensity of the lamp linearly as the lamp temperature decreases below the cold temperature threshold.

7. The method of claim 1, wherein increasing the minimum intensity of the lamp further comprises increasing the minimum intensity of the lamp according to a step function below the cold temperature threshold.

8. The method of claim 1, wherein the high-frequency output voltage is generated by a ballast circuit located close to the lamp, and the step of generating a temperature control signal comprises generating a lamp voltage control signal representative of the temperature of the ballast circuit.

9. An electronic ballast circuit for driving a gas discharge lamp, the ballast circuit comprising:
an inverter circuit for receiving a DC bus voltage and for generating a high-frequency output voltage;
a resonant tank circuit for receiving the high-frequency output voltage and generating a sinusoidal voltage for driving said lamp;
and
a control circuit operatively coupled to the inverter circuit for adjusting an intensity of the lamp between a minimum intensity and a maximum intensity, the control circuit operable to receive a control signal representative of a lamp temperature of the lamp, the control circuit operable to increase the minimum intensity of the lamp if the lamp temperature of the lamp drops below a cold temperature threshold.

10. The ballast circuit of claim 9, further comprising:
a temperature sensing circuit operable to generate the control signal representative of the lamp temperature of the lamp, the temperature sensing circuit operatively coupled to the control circuit, such that the control circuit is operable to increase the minimum intensity of the lamp if the lamp temperature of the lamp drops below the cold temperature threshold.

11. The ballast circuit of claim 10, wherein the temperature sensing circuit measures a temperature of the ballast circuit to generate the control signal, and the control circuit increases the minimum intensity of the lamp if the temperature measured by the temperature sensing circuit drops below a cold temperature threshold.

12. The ballast circuit of claim 11, wherein the control circuit increases the minimum intensity of the lamp continuously as the temperature measured by the temperature sensing circuit decreases below the cold temperature threshold.

13. The ballast circuit of claim 12, wherein the control circuit increases the minimum intensity of the lamp linearly as the temperature measured by the temperature sensing circuit decreases below the cold temperature threshold.

14. The ballast circuit of claim 11, wherein the control circuit increases the minimum intensity of the lamp according to a step function below the cold temperature threshold.

15. The ballast circuit of claim 9, wherein the control signal comprises a lamp voltage control signal representative of the magnitude of a lamp voltage across the lamp, the magnitude of the lamp voltage being dependent upon the lamp temperature of the lamp.

16. The ballast circuit of claim 15, wherein the control circuit increases the minimum intensity of the lamp if the magnitude of the lamp voltage exceeds a maximum lamp voltage limit.

17. The ballast circuit of claim 16, wherein the control circuit increases the minimum intensity of the lamp such that the magnitude of the lamp voltage across the lamp is limited to the maximum lamp voltage limit.
